(19) United States
(12) Patent Application Publication
(10) Pub. No.: US 2004/0150307 A1
(43) Pub. Date: Aug. 5, 2004

(54) Quick temperature-raising structure of cold cathode fluorescent lamp

(75) Inventor: Shu Wei Liao, Pa-Teh City (TW)

Correspondence Address: BROWDY AND NEIMARK, P.L.L.C., 624 NINTH STREET, NW, SUITE 300, WASHINGTON, DC, 20001-5303, US

(73) Assignee: ADO Enterprise Co., Ltd., Pa-The City (TW)

(21) Appl. No.: 10/357,464

(22) Filed: Feb. 4, 2003

(51) Int. Cl. H01J 61/52; H01J 7/24

(52) U.S. Cl. 313/19

(57) ABSTRACT

A quick temperature-raising structure of cold cathode fluorescent lamp comprises a cold cathode fluorescent lamp, a soft electric heating component, an insulating tube and two insulating components. The soft electric heating component adheres onto the surface of the cold cathode fluorescent lamp. The insulating tube is slipped onto the surface of the cold cathode fluorescent lamp. The two insulating components are slipped onto the joint portions at two sides of the cold cathode fluorescent lamp, the soft electric heating component and the insulating tube. Grooves are formed on the insulating components so that an external power source can provide the working power for the soft electric heating component and the cold cathode fluorescent lamp via conducting wires. The soft electric heating component can heat in advance to quickly raise the ambient temperature of the cold cathode fluorescent lamp when the cold cathode fluorescent lamp is driven.

### FIELD OF THE INVENTION

The present invention relates to a quick temperature-raising structure of cold cathode fluorescent lamp and, more particularly, to a structure capable of quickly raising the ambient temperature of a cold cathode fluorescent lamp thereof when the cold cathode fluorescent lamp is driven.

### BACKGROUND OF THE INVENTION

In a cold cathode fluorescent lamp (CCFL), mercury atoms are excited to radiate out ultraviolet (UV) lights, which then let fluorescent material emit out visible lights.

As shown in FIG. 1, a cold cathode fluorescent lamp 60 is formed by coating fluorescent lacquer on part of the inward wall of a lamp 61 made of quartz. Reflecting coating layers 62 and 63 are then deposited or added on the lamp 61 to let the cold cathode lamp have a directionality. All light emitted by the cold cathode lamp 60 will be radiated out via a radiation aperture provided by the reflecting coating layers 62 and 63.

If the cold cathode fluorescent lamp 60 is used in a car dashboard, because it is unstable at low temperatures, the brightness thereof will be unstable except after a certain time. If the ambient temperature of the cold cathode fluorescent lamp 60 can be raised instantaneously, the above drawback can be avoided.

Accordingly, the present invention aims to provide a structure capable of quickly raising the ambient temperature of a cold cathode fluorescent lamp thereof when the cold cathode fluorescent lamp is driven.

### SUMMARY OF THE INVENTION

The object of the present invention is to provide a structure capable of quickly raising the ambient temperature of a cold cathode fluorescent lamp thereof when the cold cathode fluorescent lamp is driven. Because the cold cathode fluorescent lamp is not powered ordinarily and its ambient temperature is quickly raised only when driven, the problems of more power dissipation and unstable brightness in the prior art can be solved.

To achieve the above object, in the present invention, a soft electric heating component adheres onto the surface of the cold cathode fluorescent lamp, and an insulating tube is slipped onto the surface of the cold cathode fluorescent lamp. Two insulating components are slipped onto the joint portions at two sides of the cold cathode fluorescent lamp, the soft electric heating component and the insulating tube, respectively. Grooves are formed on the insulating components so that an external power source can simultaneously provide the working power for the soft electric heating component and the cold cathode fluorescent lamp via conducting wires.

The above soft electric heating component is formed by sticking a wavy and stripy soft electric heating filament on the surface of a film sheet.

The various objects and advantages of the present invention will be more readily understood from the following detailed description when read in conjunction with the appended drawing, in which:

### BRIEF DESCRIPTION OF THE DRAWINGS

FIG. 1 is a cross-sectional view of a conventional cold cathode fluorescent lamp;

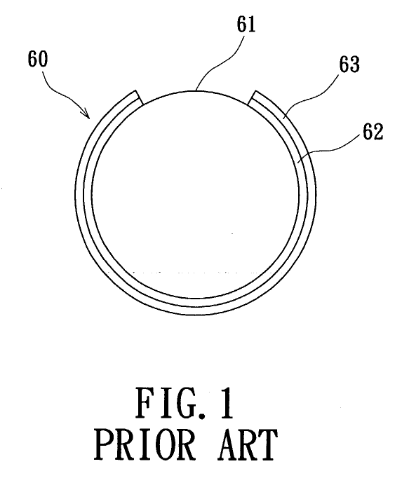

FIG. 2 is an exploded perspective view of the present invention;

FIG. 3 is another exploded perspective view of the present invention;

FIG. 4 is an perspective assembly view of the present invention; and

FIG. 5 is a partial cross-sectional view of the present invention.

### DETAILED DESCRIPTION OF THE PREFERRED EMBODIMENTS

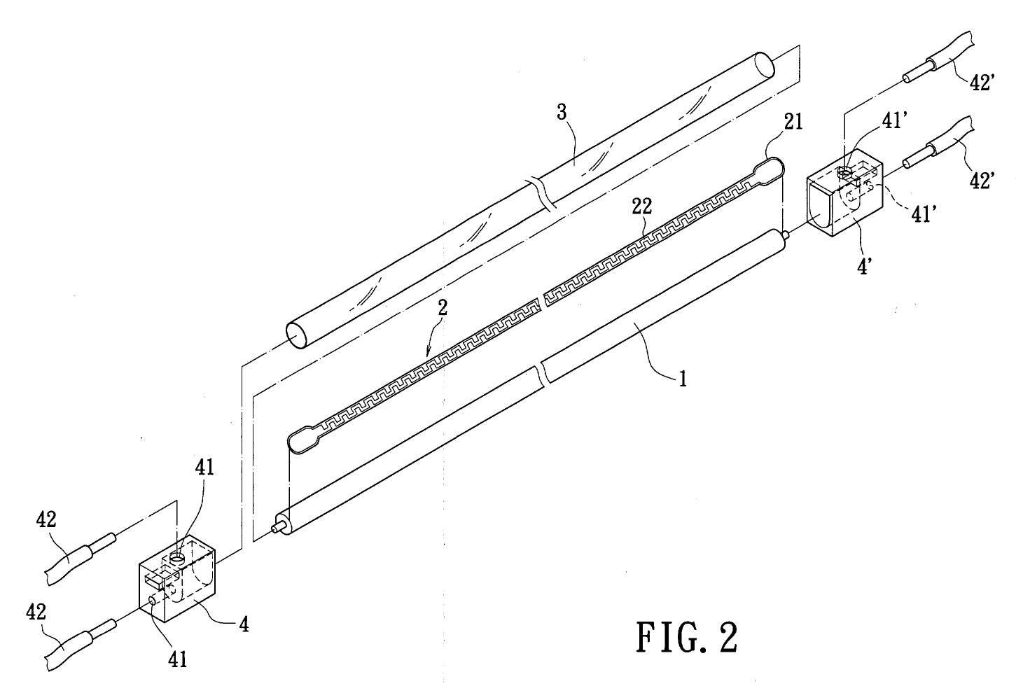

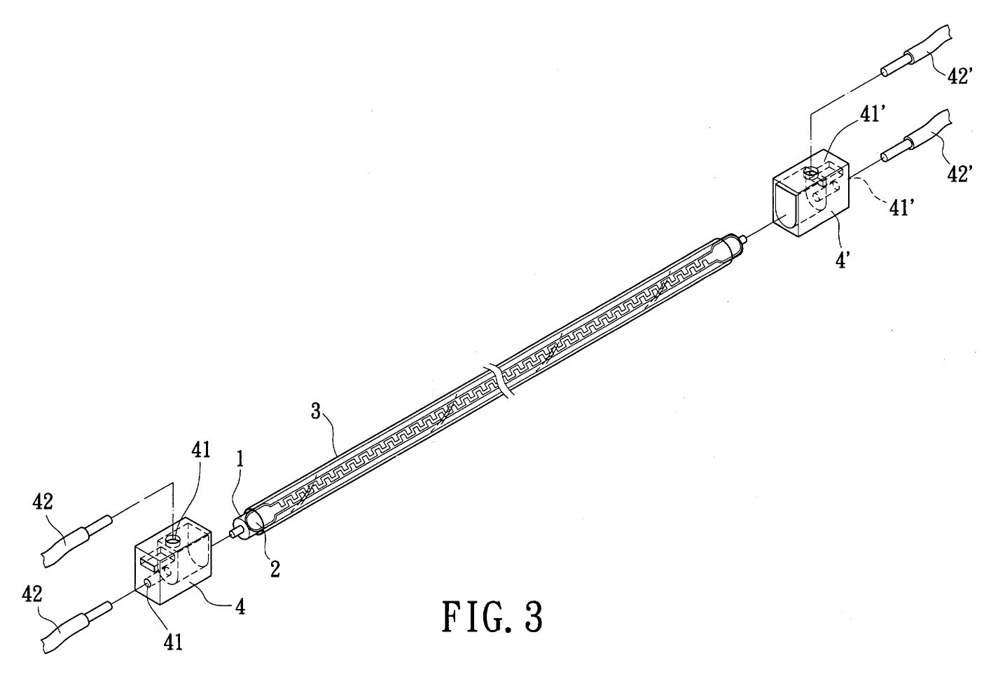

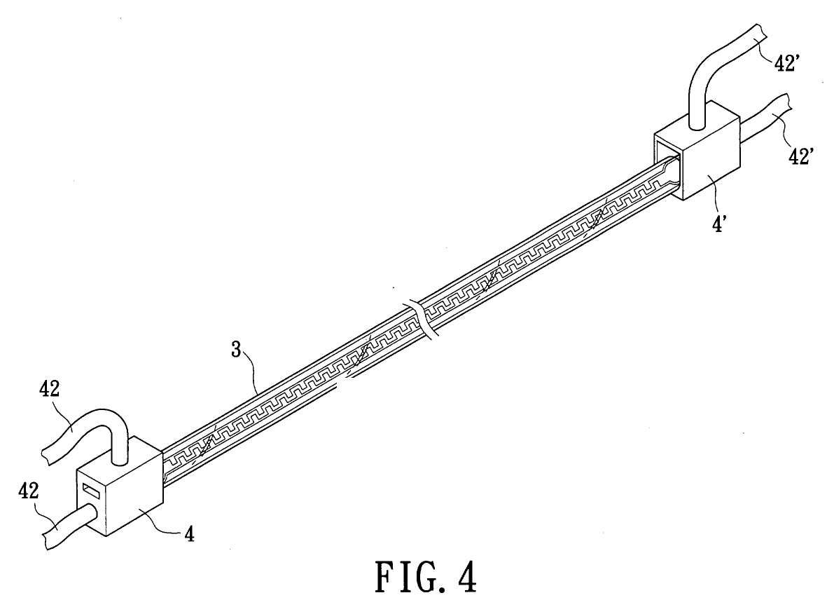

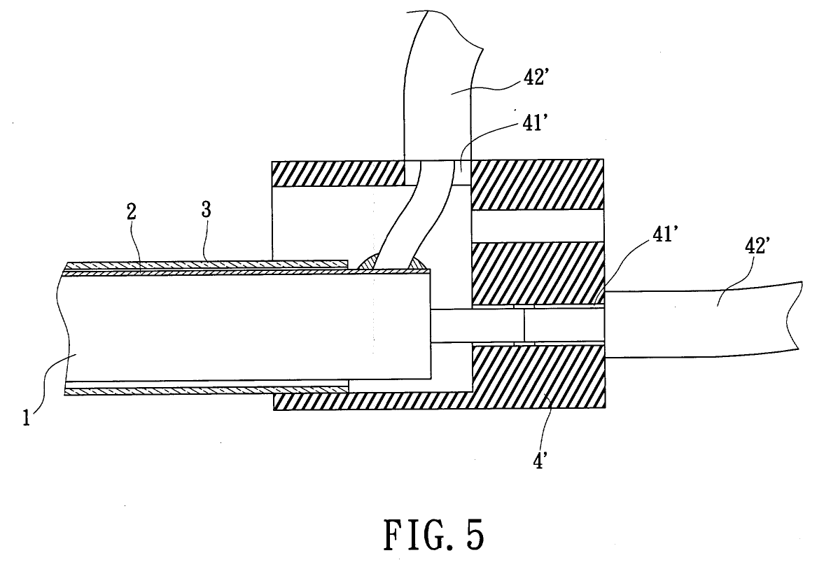

As shown in FIGS. 2 to 5, a quick temperature-raising structure of cold cathode fluorescent lamp of the present invention used in car dashboards or related electric appliances comprises a cold cathode lamp fluorescent 1, a soft electric heating component 2, an insulating tube 3 and two insulating components 4 and 4′.

The cold cathode fluorescent lamp 1 is a cold cathode light source containing mercury, and is powered by an external power source to radiate. The length of the cold cathode fluorescent lamp 1 is longer than the width thereof. The cold cathode fluorescent lamp 1 is not powered ordinarily.

The soft electric heating component 2 is formed by sticking a soft electric heating filament 22 onto a film sheet 21. In this embodiment, the soft electric heating component 2 is of a wavy and stripy shape. The soft electric heating filament 22 adheres onto the surface of the cold cathode fluorescent lamp 1 through the film sheet 21. The soft electric heating lamp 2 is powered by the above external power source to work, and can heat in advance when the cold cathode fluorescent lamp is driven.

The insulating tube 3 is a hollow transparent tube, and is slipped onto the surface of the cold cathode fluorescent lamp 1 so that the soft electric heating component 2 can be fixed on the surface of the cold cathode fluorescent lamp 1.

The insulating components 4 and 4′ are joined at the connection portions at two sides of the cold cathode fluorescent lamp 1, the electric heating component 2 and the insulating tube 3. Each of the insulating components 4 (4′) has a groove 41 (41′) so that two conducting wires 42 (42′) can be connected to a corresponding end of the soft electric heating filament 22 and the cold cathode fluorescent lamp 1.

The soft electric heating component 2 can heat in advance to quickly raise the ambient temperature of the cold cathode lamp 1 to the working temperature thereof when the cold cathode fluorescent lamp 1 is driven.

The soft electric heating component 2 can also be replaced with a soft electric heating sheet or another electric heating component having the same effect.

To sum up, through the structure design of the present invention, because the cold cathode fluorescent lamp is not powered ordinarily and its ambient temperature is quickly raised only when driven, the problems of more power dissipation and unstable brightness in the prior art can be solved.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

I claim:

1. A quick temperature-raising structure of cold cathode fluorescent lamp comprising:
a cold cathode fluorescent lamp powered by an external power source to radiate;
a soft electric heating component provided at the surface of said cold cathode lamp and powered by said external power source to work;
an insulating tube slipped onto the surface of said cold cathode fluorescent lamp so that said soft electric heating component can be fixed on the surface of said cold cathode fluorescent lamp; and
two insulating components respectively joined at the joint portions at two sides of said cold cathode fluorescent lamp, said electric heating component and said insulating tube.

2. The quick temperature raising structures of cold cathode fluorescent lamp as claimed in claim 1, wherein said soft electric heating component is formed by sticking a wavy and stripy soft electric heating filament on the surface of a film sheet.

3. The quick temperature-raising structure of cold cathode fluorescent lamp as claimed in claim 2, wherein said soft electric heating filament can be replaced with a soft electric heating sheet.

4. The quick temperature-raising structure of cold cathode fluorescent lamp as claimed in claim 1, wherein two grooves are respectively provided on said insulating components so that said external power source can provide the working power for said soft electric heating component and said cold cathode fluorescent lamp via conducting wires.
